(19) United States
(12) Patent Application Publication
(10) Pub. No.: US 2025/0135709 A1
(43) Pub. Date: May 1, 2025

(54) SYSTEM FOR PRODUCING CONTAINERS FROM PREFORMS

(71) Applicant: Krones AG, Neutraubling (DE)

(72) Inventors: Jochen FORSTHOEVEL, Regensburg (DE); Simon FISCHER, Regensburg (DE)

(21) Appl. No.: 18/925,584

(22) Filed: Oct. 24, 2024

(30) Foreign Application Priority Data
Oct. 25, 2023 (DE) 10 2023 129 371.0

(51) Int. Cl. B29C 49/64; B29C 49/42; B29C 49/78; B29L 31/00

(52) U.S. Cl. CPC B29C 49/6418; B29C 49/42065; B29C 49/786; B29C 2049/7861; B29L 2031/712

(57) ABSTRACT

A system for producing containers from preforms, the system comprising a production machine for producing preforms, a blow molding machine for producing containers from preforms, a transport device for feeding preforms from the production machine to the blow molding machine and a storage device to which preforms can be fed from the transport device at a removal point and transferred to the transport device at a transfer point, wherein the storage device comprises a temperature-control device for temperature-control of the preforms.

### CROSS REFERENCE TO RELATED APPLICATION

The present application claims priority to German Patent Application No. 10 2023 129 371.0 filed on Oct. 25, 2023. The entire contents of the above-listed application are hereby incorporated by reference for all purposes.

### TECHNICAL FIELD

The present disclosure relates to a system for producing containers from preforms and to a method for producing containers by means of a system.

### BACKGROUND

Systems for producing containers from preforms are generally known. These can be embodied in one-stage processes or in two-stage processes, wherein in the one-stage process preforms are produced in an injection molding machine and fed to a machine for producing containers from preforms (in particular blow molding machines) via a transport device, which is usually very short and leaves the preforms in a defined handling state and receives a large part of the heat from the injection molding. In the two-stage process, the preforms are produced separately and then transported, for example by truck, to the systems that produce containers from the preforms. Here, too, a direct connection between preform production and container production is possible, but the preform must be heated up again and not just conditioned.

### SUMMARY

In general, when combining preform and container production, the reliable production of the containers depends on the production machine for producing the preforms (for example an injection molding machine) and the blow molding machine being synchronized with each other so that they have substantially the same throughput. Otherwise, the preforms from the blow molding machine may back up or the blow molding machine may run idle. Both have a negative impact on operation and, in particular, the backing up of preforms can lead to them not being brought to a sufficient temperature to be reliably formed into containers. Thus, both the one-stage process and the two-stage process require heating or bringing of the preforms to a specific target temperature, but due to possible variability in the feeding of the preforms, this can sometimes be difficult to achieve with sufficient accuracy.

### Object

Based on the known prior art, the technical problem to be solved is to provide a system for producing containers from preforms and a method for producing containers from preforms, with which reliable operation of the system and, at the same time, high quality of the containers produced can be achieved.

### Solution

This object is achieved in accordance with the disclosure by the system for producing containers from preforms, as well as by the method for producing containers from preforms by means of a system as described herein.

The system according to the disclosure for producing containers from preforms comprises a production machine for producing preforms, a blow molding machine for producing containers from preforms, a transport device for feeding preforms from the production machine to the blow molding machine and a storage device to which preforms can be fed from the transport device at a removal point and transferred to the transport device at a transfer point, wherein the storage device comprises a temperature-control device for temperature-control of the preforms.

In principle, the transport device can be designed in any way. The transport device can comprise a linear conveyor (for example an air conveyor) and/or a number of rotary stars which transport the preforms from the production machine to the blow molding machine. The transport device can also comprise a sorting device which at least partially changes the spatial arrangement of the preforms after they leave the production machine and enables them to be transferred to the blow molding machine.

A switch or a controlled rotary star can be provided at the removal point and/or the transfer point, and, depending on the requirement, either feeds the preforms to the storage device or moves them further in the transport device in order to feed them to the blow molding machine for producing containers from the preforms.

The storage device can enable the preforms to be stored or backed up in an orderly or disorderly manner. An orderly storing or keeping of the preforms in this case can in particular comprise storing the preforms in a certain spatial orientation (for example hanging vertically), whereas a disorderly storage of the preforms comprises storing the preforms without a predetermined spatial orientation. The latter can be realized, for example, in the form of a silo or a box or another receptacle for preforms.

The temperature-controlled preforms can in principle be removed from the storage device at any time and fed to the transport device, optionally even when the production machine is still in operation, i.e., in particular when it is producing preforms. This can, for example, be done intermittently to the usual feeding of the preforms from the production machine to the blow molding machine, depending on a storage capacity of the storage device. If the storage device is full or reaches a certain fill level (for example 60% or 70% or 80%), the storage device can be at least partially emptied so that it is not overfilled by feeding at least a partial amount of the preforms from the storage device to the transport device (for example so many preforms that the fill level of the storage device drops to a predetermined value of at most 50% or at most 30% or any other value). Alternatively or additionally, at least some of the preforms can be fed from the storage device depending on the temperature of the preforms of the transport device.

Alternatively or additionally, it can also be provided that, for example, at certain time intervals, the preforms are partially or completely removed from the storage device and fed to the transport device. This can be done, for example, during predetermined operating breaks in the process cycle of the production machine, but is not limited to this.

The temperature-control device can, for example, comprise one or more infrared emitters and/or microwave emitters and/or a hot air supply in order to control the temperature of the preforms, in particular to keep them at a desired temperature. The temperature-control device can also comprise, for example, a plurality of heating elements, such as infrared emitters and/or microwave emitters and/or hot air supplies (or any other suitable heat source), which are arranged in different areas of the storage device, wherein preforms pass through the heating elements successively or in a cascade-like manner during transport through the storage device and/or the temperature-control device. Each of the heating elements can be designed such that it can control the temperature of preforms to a specific temperature, wherein, for example, heating elements arranged one after the other in the transport direction can be arranged from lower to higher temperature in the transport direction of the preforms through the storage device.

According to the disclosure, it is not mandatory that the preforms are permanently temperature-controlled in the storage device. In particular, the temperature-control device does not have to be continuously active when preforms are present in the storage device. For example, it can also be provided that the temperature control of the preforms is coupled to or dependent on certain process parameters. These include, for example, predetermined downtimes of the production machine (e.g., scheduled maintenance intervals or a scheduled end of operation). Alternatively or additionally, it can also be provided that the temperature control of the preforms is controlled, for example, depending on the energy costs. For example, if the system is connected to an external power grid (optionally exclusively with renewable power sources such as photovoltaics and/or wind power), the temperature-control device can be switched on at times when the external power grid supplies a surplus of power or a surplus of available electricity that exceeds the needs of other consumers, or when such a surplus is likely. This means that available renewable energy is used efficiently. At the same time, this can bring advantages in terms of operating costs.

The production machine can in principle be any machine that is suitable for producing preforms from a preform starting material (e.g., PET pellets) by, for example, melting the preform starting material and introducing the melted preform starting material into a mold or tool. The production machine can be designed in particular as an injection molding machine, although other variants known from the prior art, such as a compression molding machine, can also be used. The disclosure is not limited in this respect.

With the system according to the disclosure, by storing the preforms and controlling the temperature of the preforms during storage, even when the blow molding machine is stopped, it can be ensured that the preforms produced by the injection molding machine do not have to be rejected as scrap, but can be fed back into the transport device for further use. This improves the operation of the system and the quality of the containers produced while minimizing waste.

It can be provided that the removal point is arranged upstream or downstream of the transfer point in the transport direction of the preforms in the transport device. The feeding of the preforms at a transfer point upstream or downstream of the removal point can be selected, for example, depending on the presence of a sorting device and/or the disorderly or orderly storage of the preforms in the storage device in order to ensure the reliable feeding of the preforms to the transport device.

In one embodiment, it is provided that the system comprises a control unit for controlling the temperature-control device depending on a target temperature of the preforms.

The target temperature can in particular be a temperature which the preforms must have when they are transferred to the transport device or on which they depend. Alternatively or additionally, a target temperature of the preforms can be selected as the target temperature when they are fed into the blow molding machine, or the target temperature can depend on how high the temperature of the preforms must be when they are fed into the blow molding machine and then the target temperature can be determined, for example, taking into account the transport distance and the expected cooling of the preforms during transport. The temperature-control device can then be controlled with regard to the power or heat it emits so that the target temperature of the preforms in the storage device is reached.

It can be provided here that preforms which have reached the target temperature are fed from the storage device to the transport device. This can be done either at fixed time intervals (for example, every 30 minutes all preforms in the storage device that have reached the target temperature can be fed from the storage device to the transport device) or depending on whether one or more preforms have reached the target temperature. This embodiment can advantageously be implemented together with an orderly storage of the preforms in the storage device, but is not limited thereto.

This improves the quality of the containers produced from the stored preforms.

In particular, it can be provided that the system comprises a sensor for determining a temperature of preforms in the transport device and wherein the target temperature is dependent on the determined temperature and/or on requirements when producing containers from the preforms with the blow molding machine. The requirements for producing the containers from the preforms using the blow molding machine may include, for example, a necessary temperature of the preforms when feeding the preforms to the blow molding machine and/or a heating device (oven) of the blow molding machine. These requirements can, for example, be used in addition to or alternatively to the specific temperature to determine the target temperature of the preforms. For example, extrapolating the cooling of the preforms from the transfer point to the point where the preforms are transferred to the blow molding machine can be used to determine the target temperature based on the temperature to be reached by the preforms when the preforms are transferred to the blow molding machine.

The sensor may in particular be a thermal sensor that can determine a temperature of preforms (for example based on infrared radiation emitted by the preforms and/or a radiation spectrum of the preforms). In principle, the temperature of the preforms in the transport device can be determined at any point in the transport device and the target temperature can depend on this specific temperature. This can ensure that the temperature of the preforms fed back into the transport device corresponds to the temperature of the preforms transported in the transport device, so that the result when producing the containers is as uniform as possible.

The sensor can be arranged so that it can determine the temperature of the preforms in a region of the transfer point. With this embodiment, the target temperature of the preforms can preferably be selected such that it corresponds to the temperature of the preforms in the transport device at the transfer point, so that all preforms have the same temperature at the transfer point, regardless of whether they are fed from the storage device to the transport device or are transported in the transport device. The containers can thus be produced from the preforms with consistent quality.

The region of the transfer point is to be understood here as a region in the transport device that can extend around the transfer point. Preferably, the sensor can be arranged such that it can determine the temperature of the preforms directly at the transfer point or in a region which extends, for example, up to 10 or up to 20 or 50 cm upstream or downstream of the transport device. It is also possible to provide several sensors which are arranged one after the other in the transport direction of the preforms in order to determine not only the temperature of the preforms at a certain point, but also a temperature profile of the preforms during transport. This temperature profile can also be used instead of the specific temperature to set the target temperature, which may be possible with greater accuracy.

The control unit can be designed to control the temperature-control device such that the preforms have the target temperature at a transfer time.

If, for example, it is intended that the preforms are transferred from the storage device to the transport device at a certain time (the transfer time or the transfer point in time), the temperature-control device can be switched on and/or switched off and/or controlled in terms of its performance so that the preforms have the target temperature when the transfer time is reached. Since the preforms are usually fed to the storage device at different times, the temperature-control device can either be controlled so that the preforms have the desired target temperature on average (on average over the temperature of a large number of preforms that are simultaneously in the storage device but were fed to it at different times) or the temperature-control device can be designed so that it can control the temperature of preforms fed at different times differently, for example by providing several independently controllable heaters that can heat certain areas of the storage device to which the preforms are fed depending on their feed time to the storage device. This can save energy because the temperature-control device can be controlled so that only the heat energy required to reach the target temperature is released.

It can be provided that the control unit is designed to control the temperature-control device depending on a planned end of operation of the production machine such that the preforms have the target temperature at the planned end of operation.

The planned end of operation can, for example, be a time when the container type is changed or when there is a maintenance interval or another interruption in the operation of the production machine. In this case, the end of operation of the production machine does not mean the end of operation of the system, but simply means that the production machine no longer produces any more preforms. However, since preforms may still be present in the storage device, these can be further processed by the blow molding machine after the production machine has stopped operating. This simplifies the feeding of the preforms from the storage device to the transport device during operation and at the same time minimizes waste, since the preforms are preferably completely formed into containers.

The system can be designed in such a way that the preforms are fed to the transport device from the storage device when there are no more preforms in the transport device upstream of the transfer point.

After the machines have finished operating for production, the preforms from the production machine are still fed to the blow molding machine without any new preforms being added from the production machine. This means that after a certain time after the end of operation of the production machine, there are no more preforms upstream of the transfer point, so that the preforms can be fed unhindered from the storage device to the transport device.

According to the disclosure, a method for producing containers from preforms by means of a system is further provided, the system comprising a production machine for producing preforms, a blow molding machine for producing containers from preforms, a transport device for feeding preforms from the production machine to the blow molding machine and a storage device to which preforms can be fed from the transport device at a removal point and transferred to the transport device at a transfer point, wherein the storage device comprises a temperature-control device for temperature-control of the preforms, the method comprising feeding preforms from the storage device to the transport device when there are no preforms upstream of the transfer point, at least temporarily.

This method enables reliable production of containers from preforms while also reducing waste.

It can be provided that the removal point is arranged upstream or downstream of the transfer point in the transport direction of the preforms in the transport device. The arrangement of the removal point and transfer point can be selected according to suitability in order to ensure reliable operation of the system.

It can be provided that the system comprises a control unit which controls the temperature-control device depending on a target temperature of the preforms. This ensures reliable production of containers from preforms from the storage device.

Furthermore, it can be provided that the system comprises a sensor for determining a temperature of preforms in the transport device and wherein the target temperature is dependent on the determined temperature, wherein optionally the sensor is arranged such that it determines the temperature of the preforms in a region of the transfer point.

This embodiment ensures the consistent quality of the containers produced from preforms, regardless of whether they are fed directly from the production machine to the blow molding machine or whether they are temporarily stored in the storage device.

In one embodiment, it is provided that the control unit controls the temperature-control device such that the preforms have the target temperature at a transfer time. The energy required for controlling the temperature of the preforms can thus be reduced.

It can be provided that the control unit controls the temperature-control device depending on a planned end of operation of the production machine such that the preforms have the target temperature at the planned end of operation. This makes it possible to feed the preforms stored in the storage device to the transport device without complications.

The control unit may determine the end of operation based on a number of preforms in the storage device and/or based on a number of containers to be produced. This embodiment ensures that sufficient containers are produced while minimizing waste.

### BRIEF DESCRIPTION OF THE FIGURES

FIG. 1 shows a schematic view of an embodiment of a system.

FIG. 2 shows a flow chart of a method for controlling the temperature-control device to achieve a target temperature of the preforms.

FIG. 3 shows a flow chart of a method for controlling the temperature-control device and for feeding the preforms to the storage device at an end of operation of the production machine.

### DETAILED DESCRIPTION

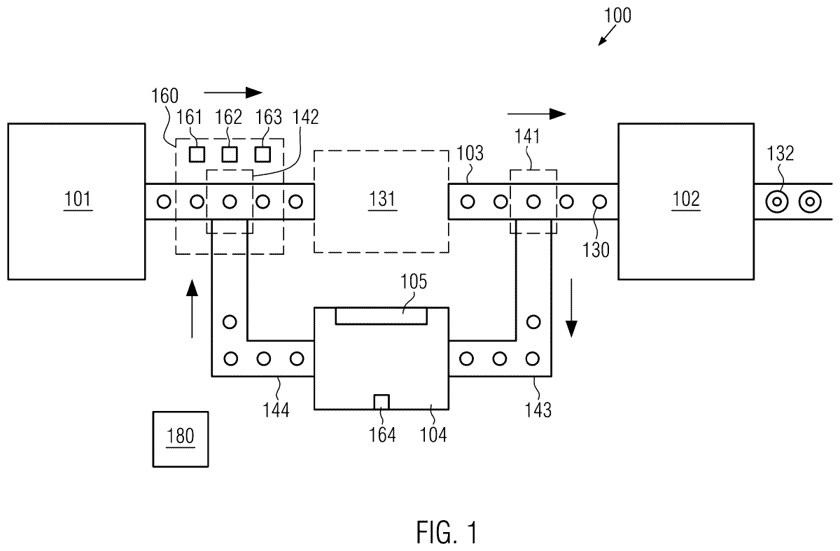

FIG. 1 shows a system for producing containers 132 from preforms 130.

The system comprises a production machine 101 with which preforms 130 can be produced. The production machine 101 can, for example, be designed as an injection molding machine in which heated preform starting material (for example PET) is fed to a tool in which the preforms are formed by injecting the heated preform starting material. The preforms can then optionally be cooled and removed from the tool. Instead of an injection molding machine, an injection molding machine or a compression molding machine can also be used as a production machine. All of these machines are basically known from the prior art and their further design will not be described here in greater detail. The disclosure is fundamentally not limited with regard to the design of the production machine.

The system 100 further comprises a blow molding machine 102 for producing containers 132 from the preforms 130. The blow molding machine 102 can, for example, be designed as a stretch blow molding machine and, by the action of compressed air and/or a stretch rod in the interior of the preform, can cause the preform to expand so that its outer surface rests against the inner wall of a blow mold of the blow molding machine. Corresponding blow molding machines are sufficiently known from the prior art and the blow molding machine 102 can be designed in particular as a rotary machine with a carousel that is mounted so as to be rotatable about an axis of rotation and at the periphery of which a number of blow molds are arranged for receiving and molding preforms into containers. However, the disclosure is not limited in this respect and any blow molding machine capable of producing containers from preforms may be provided.

According to the disclosure, a transport device 103 is provided, with which the preforms are fed from the production machine 101 to the blow molding machine 102. In principle, the transport device 103 can be designed in any way. In particular, the transport device 103 can comprise an air conveyor with which the preforms are transported, for example, hanging between air conveyor rails on their support ring and by generating a compressed air flow in the direction of the blow molding machine. Alternatively or additionally, a conveyor inclined downwards in the transport direction (in the direction of gravity) can be provided, in which the preforms can be transported solely or substantially due to the gravity acting on them. Alternatively or additionally, one or more rotary stars can be provided, which can pick up the preforms, for example by means of individually actuatable clamps at the periphery of the rotary stars, and can transport them from the production machine 101 in the direction of the blow molding machine. Also conceivable are transport devices that transport preforms using electromagnetic forces. In particular, long stators with movers arranged thereon that can transport one or more preforms can be provided here. Combinations of these or other transport devices may also be provided to enable the preforms to be transferred from the production machine to the blow molding machine 102.

Optionally, a sorting device 131, shown only schematically here, can be arranged either in the region of the transport device or as part of the production machine 101 and sorts the preforms coming from the production machine 101. Preform sorting means any manipulation of the arrangement of the preforms which imposes a new orientation or arrangement on the preforms from an initial orientation or arrangement (which may be orderly or disorderly, in particular random or chaotic). If the preforms are produced in the production machine 101, for example in a regular pattern in the form of a two-dimensional matrix in a tool and then transferred to a disorderly stockpile, the sorting device 131 can be designed such that after taking over the random preforms, it aligns the preforms so that they are transferred to the transport device 103, for example all hanging on their support ring and aligned so that the opening area of the preform faces upwards. For this purpose, it can be provided that the transport device 103 is designed, for example, in two parts, wherein a first part of the transport device extends from the production machine 101 to the sorting device 131. This part of the transport device can, for example, enable a random transport of preforms coming from the production machine and can be designed as a conveyor belt, for example. These preforms can then be sorted in the sorting device 131 and subsequently fed with the intended orientation to a second part of the transport device 103, which can then be designed, for example, as an air conveyor and/or comprising one or more rotary stars.

The sorting device is designed here in such a way that it can enable a transfer to the second part of the transport device. Such sorting devices are known in principle from the prior art and include, for example, roller sorters or disc sorters.

The blow molding machine 102 may optionally also include a heating device arranged upstream of a blow molding region in which the preforms are formed into containers. The heating device can comprise one or more heating emitters, for example infrared emitters or microwave emitters, which can control the temperature of the preforms to a certain temperature after they have been transferred to this heating device from the transport device 103. It is also possible to emboss a desired temperature profile (a temperature curve, for example, along the length of the preform) into the preform.

According to the disclosure, the system 100 further comprises a storage device 104 to which preforms can be fed. This is done by removing the preforms from the transport device 103 at a removal point 141 and feeding them to the storage device 104, for example via a suitable transport device 143. The transport device 143 (also discharge transport device) is connected to the transport device 103 in such a way that preforms can preferably be selectively removed from the transport device 103 at the removal point 141 and fed to the transport device 143. This can be realized, for example, by arranging a switch as a transport device 103 in an air conveyor for conveying the preforms, so that at the removal point 141 the air conveyor can branch off in the direction of the storage device 104. If the switch is switched and/or a blocking element is actuated to block the transport device 103 downstream of the switch, the preforms can be diverted into the transport device 143.

If the transport device 103 is designed as a series of rotary stars, it can be provided that a rotary star can be actuated in the removal point 141 in order to either transfer the preforms to a subsequent rotary star in the transport direction towards the blow molding machine 102 or to transfer the preforms to a rotary star of the transport device 143 so that they can be fed to the storage device 104.

Furthermore, it is provided that preforms from the storage device 104 can be fed again to the transport device 103 at a transfer point 142. For this purpose, a further transport device 144 (also feed transport device) can be provided analogously to the transport device 143 and can remove the preforms from the storage device 104 and feed them to the transport device 103 at the transfer point 142. This can be realized analogously to the design of the transport device 143 in the removal point 141. Alternatively, it can be provided, for example, that in the event that the transport device 103 is provided upstream of a sorting device 131 as a device for the random transport of the preforms, the further transport device 144 is also designed for the random transport of the preforms from the storage device 104, for example as a chute on which the preforms can be conveyed along a gradient from the storage device 104 in the direction of the transfer point 142.

The storage device 104 can be designed for the orderly or disorderly keeping or storing of preforms. If the storage device 104 is designed for the orderly storage of the preforms, the storage device can be designed, for example, as a storage rail or as a buffer system in which the preforms are held in a specific orientation. If the storage device 104 is designed to store preforms in the form of a disorderly supply, it can be provided that the storage device comprises, for example, a receiving container, such as a silo or the like, to which the preforms are fed and in which they are stored in a disorderly manner or without any imposed order. In this embodiment, it is particularly advantageous if the further transport device 144 is designed for the disorderly transport of the preforms.

According to the disclosure, the storage device comprises a temperature-control device 105 for controlling the temperature of the preforms in the storage device 104. The temperature-control device 105 can, for example, comprise one or more microwave emitters or infrared emitters or can also comprise a warm air blower with which the preforms can be exposed to thermal energy.

If the storage device is designed, for example, as a storage device for the orderly storage of the preforms (as described above), it can be provided that the temperature-control device 105 comprises multiple heating elements along a transport direction of the preforms in the storage device 104, such as the described microwave emitters and/or infrared emitters. Their temperature and/or heat output can then be controlled in such a way that heating elements arranged downstream in the transport direction of the preforms in the storage device each have a higher temperature than the heating element arranged immediately upstream. Each heating element can comprise a single microwave emitter and/or infrared emitter (or similar heat source) or each heating element can comprise, in the sense of a group, several heat sources (microwave emitters and/or infrared emitters or similar) set to the same temperature and/or heat output.

In the embodiment shown in FIG. 1, the removal point 141 is located downstream of the transfer point 142. However, this is not mandatory. The removal point 141 can also be arranged upstream of the transfer point 142, viewed in the transport direction of the preforms in the transport direction 103. The distance between the transfer point and the removal point is not limited according to the disclosure, but preferably extends such that, if a sorting device 131 is provided, the removal point is arranged after the sorting device (downstream) in the transport device 103 and the transfer point is arranged upstream of the sorting device 131 in the transport direction of the preforms in the transport device 103. This makes it possible for the preforms fed from the transport device 103 to the storage device to be stored in an disorderly manner in the storage device. This can make storing the preforms easier.

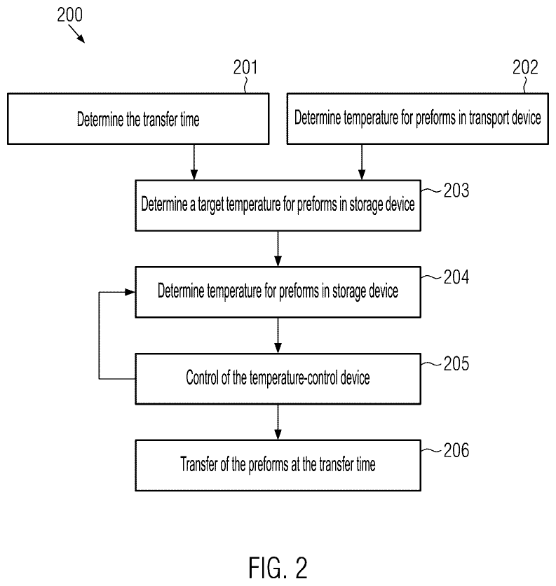

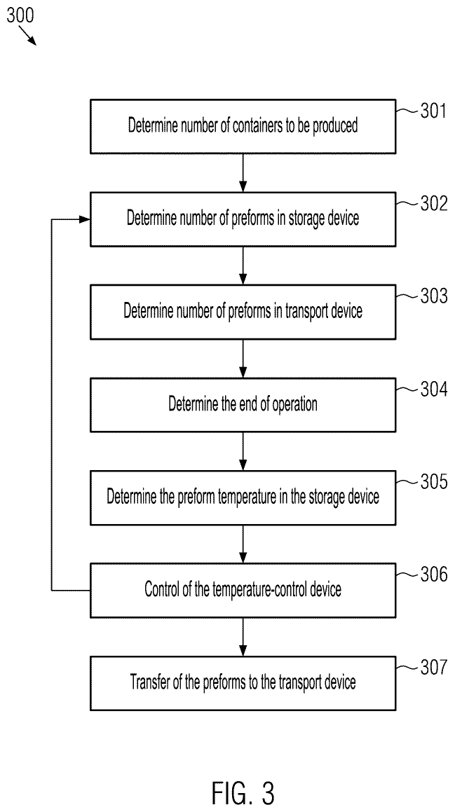

Optionally, a control unit 180, for example in the form of a computer with associated memory and processor, can be provided as part of the system and can be designed to control the temperature-control device 105 and/or the removal of preforms from the transport device 103 to the storage device 104 and/or the feeding of preforms to the transport device from the storage device. This may, for example, include the control unit controlling the temperature-control device depending on certain other parameters, for example a (target) temperature to be reached by the preforms when they are transferred to the transport device from the storage device, or the temperature control of the preforms to a temperature that they are to assume when the production machine ends its operation. This will be described further with reference to FIGS. 2 and 3.

In order to enable control of the temperature-control device 105 by the control unit 180, it can be provided that one or more sensors 161 to 163 are arranged in the region of the transport device 103 in order to determine the temperature of the preforms in the transport device. Optionally, a further sensor 164 can also be provided in the region of the storage device in order to determine the temperature of the preforms in the storage device 104. Instead of one sensor 164 in the region of the storage device 104, a plurality of sensors 164 can also be provided in the storage device 104 in order to enable precise measurement of the temperature of all preforms in the storage device. This can be particularly advantageous in the case of disorderly storage of the preforms in the storage device.

In one embodiment, it is particularly advantageous if the one or more sensors 161 to 163 for determining the temperature of the preforms in the transport device 103 are arranged in a region 160 of the transfer point 142 such that they can determine the temperature of the preforms in the transport device 103 in this region 160. This can be used advantageously to determine the temperature of the preforms in the transfer point or in the region 160 and the control unit 180 can be designed to control the temperature-control device 105 based on this temperature so that the preforms which are transferred from the storage device of the transport device 103 in the transfer point have substantially the same temperature as the preforms 130 in the transfer point.

The fact that the preforms have substantially the same temperature may include the fact that the preforms either have identical temperatures or that a temperature difference of up to +/−0.2K or up to +/−0.5K, compared to the preforms in the transport device 103, is permissible for the preforms fed to the transport device 103. Based on this, the temperature-control device 105 can then be controlled by the control unit 180 so that the preforms have the desired target temperature. This can either be identical to the temperature of the preforms in the transport device 103 or can be slightly higher, for example in order to compensate for heat loss of the preforms during transport from the storage device to the transfer point.

FIG. 2 shows a flow chart of an embodiment of a method for controlling the temperature-control device based on a transfer time of the preforms from the storage device to the transport device. This method can be carried out with the system according to any of the embodiments described in conjunction with FIG. 1.

The method first comprises determining a desired transfer time of preforms from the storage device to the transport device. This transfer time can be selected, for example, based on a break or production interruption of the production machine 101 (see FIG. 1) or determined based on a gap in the flow of preforms in the transport device 103. The transfer time can also be set at fixed intervals (for example every 30 minutes or every hour or every two hours) or can be determined as required depending on the fill level of the storage device, for example to avoid the storage device becoming overfilled. It is also conceivable to set the transfer time according to the time of day (for example, depending on the electricity costs of external power sources already discussed or an expected surplus of power from these external power sources). In addition, in step 202, the temperature of the preforms in the transport device, in particular at the transfer point (see FIG. 1), can be determined.

Based on the determined transfer time and/or the determined temperature of the preforms in the transport device in steps 201 and 202, a target temperature of the preforms in the storage device can then be determined in step 203, for example by the control unit 180. The target temperature can be defined (particularly but not exclusively in the case of an orderly storage of the preforms in the storage device) for all or only a real partial amount of the preforms in the storage device (for example a number of preforms that can be fed to the transport device during a production interruption of the production machine of a certain duration). The target temperature will usually be greater than, but at most equal to, the temperature of the preforms in the transport device (for example in the transfer point) and can be determined by the control unit not only depending on the specific transfer time and/or the specific temperature of the preforms in the transport device, but can also be based on, for example, other information available to the control unit, such as an ambient temperature or an expected heat loss of the preforms after leaving the storage device.

Once the target temperature has been determined, the temperature-control device 205 can then be controlled in such a way that the preforms (either all preforms or the partial amount) are heated to the target temperature. For this purpose, the temperature-control device can be controlled in step 205, for example, in such a way that it can heat the preforms or the partial amount to the target temperature in the time still available up to the transfer time. This can be ensured either by the control unit controlling the temperature-control device to deliver a predetermined amount of heat per unit of time or by a control loop. This control loop may include first determining a temperature of the preforms or the partial amount in the storage device in step 204 and optionally comparing it with the target temperature. Based on the temperature difference between the preforms in the storage device and the target temperature, as well as taking into account the time still available until the transfer time, the control unit can then determine how much heat must be transferred to the preforms or the partial amount during this time in order to heat them to the target temperature. Based on this, the temperature-control device can then be controlled.

After a certain time has elapsed (for example a few seconds or minutes), the temperature of the preforms or the partial amount in the storage device can then be determined again and, by checking the temperature of the preforms, the temperature-control device can be further controlled in order to bring about a faster or slower heating of the preforms or the partial amount, if necessary. For example, depending on the fill level of the storage device, an increased heat output from the temperature-control device may be necessary in order to heat the preforms or the partial amount in the storage device to the desired temperature within the specified time up to the transfer time. This can be taken into account by the control loop described.

Once the preforms or the partial amount of preforms have reached the target temperature, they can be transferred to the transport device at the transfer time (206). Depending on whether all preforms or only a partial amount of the preforms in the storage device are transferred to the transport device at the transfer time, the storage device is empty after completion of the transfer or still contains preforms. In the latter case, it can be provided that in a next case in which preforms are to be transferred to the transport unit again, first the remaining preforms and then preforms newly fed to the storage device in the meantime are heated by the temperature-control device. This keeps the holding time of preforms in the storage device as short as possible.

FIG. 3 shows a further embodiment of a method for controlling the temperature-control device and transferring the preforms to the transport device for producing containers from these preforms. In this embodiment, an operating end of the production machine (see FIG. 1) is provided. At the same time, a certain number of containers are to be produced.

The method 300 begins in step 301 in this embodiment with a determination of the number of containers to be produced. This number of containers to be produced can, for example, be a remaining number of containers to be produced. For example, if an order requires a total of 150,000 containers and 100,000 containers have been produced so far, a further 50,000 containers will need to be produced.

Since preforms may not only be supplied from the production machine upstream of the blow molding machine but may also be available in the storage device, the number of preforms in the storage device and the number of preforms in the transport device may be determined in steps 302 and 303. Based on this number, it can be determined whether more preforms need to be produced by the production machine. If the total number of preforms in the storage device and the transport device according to steps 302 and 303 is, for example, 25,000, it is still necessary to produce a further 25,000 preforms with the production machine. While steps 302 and 303 are shown here one after the other, it is also conceivable that these steps are carried out simultaneously or in a reversed order.

In step 304, an end of operation of the production machine is then determined based on the number of containers to be produced and/or the number of preforms in the storage device and/or the number of preforms in the transport device. This end of operation defines when the production machine stops producing preforms. This can either be a complete end of operation (i.e., the point in time at which the production machine has produced all the containers to be produced) or a break in operation (for example after producing a certain partial number of containers to be produced), after which the production machine produces further preforms. Several operational breaks of this kind may be planned until the number of containers to be produced is reached.

The time until this end of operation can, for example, be specified as a multiple of an operating cycle, wherein an operating cycle comprises exactly one production cycle of the production machine. Alternatively, the time until the end of operation can also be displayed as a time interval (for example minutes or hours).

In this embodiment, it is provided that when the end of operation is reached, no more preforms are produced by the production machine (in the case of a break in operation, at least until operation is next resumed) and instead the preforms still remaining in the transport device and/or present in the storage device are fed to the blow molding machine. For this purpose, it can be particularly advantageously provided that when the end of operation is reached and in particular when the transport device is emptied up to the transfer point, preforms are fed from the storage device to the transport device, since no further preforms follow from the direction of the production machine (in the event of a break in operation, at least until operation is next resumed) and thus an unhindered transport of the preforms from the storage device to the transport device can take place.

Depending on this point in time of the end of operation and/or the emptying of the transport device up to the transfer point, the temperature-control device can then be controlled in step 306 such that the preforms in the storage device have a desired temperature (target temperature) when the end of operation is reached. In this case, in step 305, analogously to step 204 of FIG. 2, the temperature of the preforms in the storage device can optionally be determined in order to then control the temperature-control unit based on this.

Since the feeding of preforms to the storage device can also take place during operation, for example if the blow molding machine fails unintentionally, it can be provided that steps 302 to 306 are carried out again in the form of a control loop, wherein the number of preforms in the storage device and the remaining number of preforms in the transport device are determined at regular intervals in order to determine the end of operation, and based on this and optionally the preform temperatures of the storage devices, the controller controls the temperature-control devices.

In step 307, when the end of operation is reached and/or after the transport device has been emptied to the transfer point, the preforms are transferred from the storage device to the transport device, wherein they then have the desired temperature. It is understood that the target temperature of the preforms can be determined, for example, based on the method of FIG. 2.

1. System for producing containers from preforms, the system comprising a production machine for producing preforms, a blow molding machine for producing containers from preforms, a transport device for feeding preforms from the production machine to the blow molding machine and a storage device, to which preforms can be fed from the transport device at a removal point and transferred to the transport device at a transfer point, wherein the storage device comprises a temperature-control device for temperature-control of the preforms.

2. System according to claim 1, wherein the removal point is arranged upstream or downstream of the transfer point in the transport direction of the preforms in the transport device.

3. System according to claim 1, wherein the system comprises a control unit for controlling the temperature-control device depending on a target temperature of the preforms.

4. System according to claim 3, wherein the system comprises a sensor for determining a temperature of preforms in the transport device and wherein the target temperature is dependent on the determined temperature and/or on requirements when producing containers from the preforms with the blow molding machine.

5. System according to claim 4, wherein the sensor is arranged so that it can determine the temperature of the preforms in a region of the transfer point.

6. System according to claim 3, wherein the control unit is designed to control the temperature-control device such that the preforms have the target temperature at a transfer time.

7. System according to claim 3, wherein the control unit is designed to control the temperature-control device depending on a planned end of operation of the production machine such that the preforms have the target temperature at the planned end of operation.

8. System according to claim 7, wherein the system is designed in such a way that the preforms are fed to the transport device from the storage device when there are no more preforms in the transport device upstream of the transfer point.

9. Method for producing containers from preforms by means of a system, the system comprising a production machine for producing preforms, a blow molding machine for producing containers from preforms, a transport device for feeding preforms from the production machine to the blow molding machine and a storage device to which preforms can be fed from the transport device at a removal point and transferred to the transport device at a transfer point, wherein the storage device comprises a temperature-control device for temperature-control of the preforms, the method comprising feeding preforms from the storage device to the transport device when there are no preforms upstream of the transfer point, at least temporarily.

10. Method according to claim 9, wherein the removal point is arranged upstream or downstream of the transfer point in the transport direction of the preforms in the transport device.

11. Method according to claim 9, wherein the system comprises a control unit which controls the temperature-control device depending on a target temperature of the preforms.

12. Method according to claim 11, wherein the system comprises a sensor for determining a temperature of preforms in the transport device and wherein the target temperature is dependent on the determined temperature, wherein optionally the sensor is arranged such that it determines the temperature of the preforms in a region of the transfer point.

13. Method according to claim 11, wherein the control unit controls the temperature-control device such that the preforms have the target temperature at a transfer time.

14. Method according to claim 13, wherein the control unit controls the temperature-control device depending on a planned end of operation of the production machine such that the preforms have the target temperature at the planned end of operation.

15. Method according to claim 13, wherein the control unit determines the end of operation based on a number of preforms in the storage device and/or based on a number of containers to be produced.
